(19) United States
(12) Patent Application Publication
(10) Pub. No.: US 2009/0205735 A1
(43) Pub. Date: Aug. 20, 2009

(54) Elastic hose assembly

(76) Inventors: Klaus Schmelter, Brilon (DE); Anton Besche, Korbach (DE)

Correspondence Address: WALTER OTTESEN, PO BOX 4026, GAITHERSBURG, MD, 20885-4026, US

(21) Appl. No.: 12/453,023

(22) Filed: Apr. 28, 2009

Related U.S. Application Data
(63) Continuation of application No. PCT/EP2007/059810, filed on Sep. 18, 2007.

(30) Foreign Application Priority Data
Oct. 28, 2006 (DE) 10 2006 050 945.5

(51) Int. Cl. F16L 11/00

(52) U.S. Cl. 138/109; 138/120; 138/126

(57) ABSTRACT

Elastic hose (1) of finite length which, in at least one segment (9) of its overall length, has a cross-sectional shape (11) which deviates from a circular cross section (10) up to a pressure considerably below the operating pressure. The sum of the partial segments (9) with the cross section (10) which deviates from the circular shape is less than the overall length of the molded hose (1) and the molded hose (1) has an approximately circular cross section (10) in the remaining partial lengths or segments (2, 5). The transitions (6, 7) from the cross section (11) which deviates from the circular shape to the circular cross section (10) run continuously in transition regions (6, 7). The transition regions (6, 7) are spaced apart from the connecting ends (2, 5) of the molded hose (1) in such a way that they lie outside the clamping zone of the connecting ends (2, 5) to connecting fittings (3). This permits a fast volume increase of the medium to be conducted even at low pressures without losses in fatigue strength, since the rigid clamping location (3, 4) has no influence on the cross section transitions (6, 7).

### CROSS REFERENCE TO RELATED APPLICATIONS

This application is a continuation application of international patent application PCT/EP 2007/059810, filed Sep. 18, 2007, designating the United States and claiming priority from German application 10 2006 050 945.5, filed Oct. 28, 2006, and the entire content of both applications is incorporated herein by reference.

### FIELD OF THE INVENTION

The invention relates to an elastic hose of finite length for the return line of a hydraulic power-assisted steering system in motor vehicles with the hose being produced from a matrix of elastomeric material with reinforcement embedded in the matrix. The elastic hose is fixedly clamped at its connecting ends to connecting fittings.

### BACKGROUND OF THE INVENTION

These types of hoses have been in use for a long time for a variety of purposes. In hydraulic power-assisted steering systems, in particular in the return line of the hydraulic medium, in certain operating situations, a pressure spike can occur in the hose even at otherwise low pressures. This pressure spike is triggered by a sudden increase in the volume of the medium and, in particular in luxury vehicles, can result in an unpleasant noise. This noise also occurs if the medium cannot flow in fast enough as the pressure spike abates and a flow interruption occurs.

The normal elastic expansibility of the hoses used in this case is usually not sufficient to accommodate the additional volume that occurs suddenly at low pressures. Correspondingly, the volume missing locally when the flow is interrupted cannot be supplied or cannot be supplied rapidly enough.

In order to absorb the sudden increase or reduction in volume in hoses, compensating vessels, which can accommodate the additional volumes that suddenly occur, are conventionally connected into the hose system.

In the area of application mentioned above, this possibility is not advantageous in view of the tight installation space in motor vehicles, on the one hand, and for cost reasons, on the other hand.

Another possibility to accommodate additional volume in hoses is provided in DE 24 56 348 U1. A hose that is initially laid flat is then brought into the conventional shape with a circular cross-section by increasing the volume of fluid. This is possible because the hose experiences an increase in volume through the increase in its cross section with the length remaining approximately the same. The solution disclosed in this publication also permits the simple attachment of cylindrical fittings as the hose can be easily widened at the ends.

Similar solutions are also disclosed in AT 3 10 514 B, U.S. Pat. No. 4,228,824 or DE 83 13 720 U1.

In these latter solutions, the problem is that in the pressureless state or in the state of very low pressure, the hoses continually have a flattened form. This flattened form has to transfer into the round cross section over a relatively short length at the ends that are clamped to a fitting. This is not critical where the hoses are charged with full pressure in only a relatively slow manner. When the hoses are used in systems where the rise in pressure in the hose is very rapid and comes in sudden bursts, for example in the case of the aforementioned hydraulic power-assisted steering system, it can result in fatigue failure of the reinforcement in the vicinity of the clamping to the fitting in the above-mentioned transition region from flat cross section to circular cross section because the clamping point is rigid and the strongest relative movement of the reinforcement is precisely here.

### SUMMARY OF THE INVENTION

It is the object of the invention to provide a hose of the above type, which enables a rapid increase and decrease in the volume of the medium to be conveyed even at low pressures without losses in the permanent strength. This solution avoids the aforementioned disadvantages.

This object is achieved in that the hose is realized as a molded hose, which, on at least one part of its overall length, has a cross section which deviates from the circular cross section up to a pressure that is considerably below the operating pressure. The sum of the partial lengths or segments with the cross section which deviates from the circular cross section is less than the overall length of the molded hose and the molded hose has an approximately circular cross section in the remaining partial lengths or segments.

Because the molded hose has a cross section that deviates from the circular cross section in the aforementioned partial lengths, for example an oval or elliptical cross section, the volume in these partial lengths is reduced compared to a circular cross section. If there is a sudden increase in the volume of the fluid in the molded hose, the molded hose, on account of its elasticity, can very rapidly assume a circular cross section in the aforementioned partial lengths, even at the lowest pressures, and in so doing in many cases can accommodate the additional volume entirely so that there is no pressure spike that is linked to noise. The volume accommodated can also be discharged equally rapidly so that the danger of flow interruptions on account of the lack of volume is minimized.

In another embodiment of the invention, the transitions from the partial lengths with the cross section that deviates from the circular cross section into the partial lengths with the circular cross section run continuously in transition regions over a predetermined length. The transition regions are spaced from the connecting ends of the molded hose in such a manner that they lie outside of the clamping zone of the connecting ends to the connecting fittings.

The advantage of this arrangement is that cross-sectional changes of the molded hose take place entirely in the elastic region of the molded hose. Consequently, discontinuity in the distribution of stress, as is formed by the clamping to the rigid connecting fitting, has no negative influence on the distribution of stress when moving from one cross section to another. The flexural fatigue stress of the reinforcement and of the elastomer in the aforementioned transition regions is consequently less intense as the stress is continuously distributed to the transition regions without being limited by the clamping location so that the permanent strength of the molded hose is not decreased or is only decreased slightly by the alternating stress.

Using the molded hoses according to the invention, the aforementioned pressure spikes, which are linked to noises and are caused by a sudden increase or reduction in the volume in the molded hose, are therefore avoidable even without the need for additional components and without significant disadvantages to the permanent strength of the hoses.

### BRIEF DESCRIPTION OF THE DRAWINGS

The invention will now be described with reference to the drawings wherein:

FIG. 1 is a side elevation view of a partial section of a molded hose according to the invention;

FIG. 2 is a plan view of the molded hose section in FIG. 1; and,

FIGS. 3 and 4 show two cross sections of the molded hose shown in FIGS. 1 and 2.

### DESCRIPTION OF THE PREFERRED EMBODIMENTS OF THE INVENTION

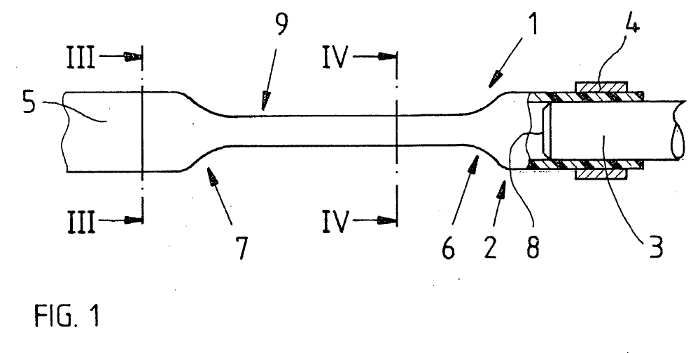

FIG. 1 shows a partial section of a molded hose 1 according to the invention. The molded hose 1 is pushed over a hose nipple 3 with one of its connecting ends 2 and is fixedly clamped with a hose clamp 4. The connecting end 2 and the other connecting end 5 have an approximately circular cross section.

The circular cross section of the molded hose 1 passes into an oval cross section in two transition regions 6 and 7.

The transition region 6 is spaced from the clamping zone whereat the connecting end is clamped to the hose nipple 3 in such a manner that the rigid end 8 of the hose nipple 3 positioned in the molded hose no longer has any supporting influence on the cross-sectional transition 6. The same applies to the transition region 7, the corresponding clamping not being shown in this case.

The molded hose, therefore, forms a segment 9 between the transition regions 6 and 7 with this segment 9 having a cross section that departs from the circular cross section, in this case an oval cross section.

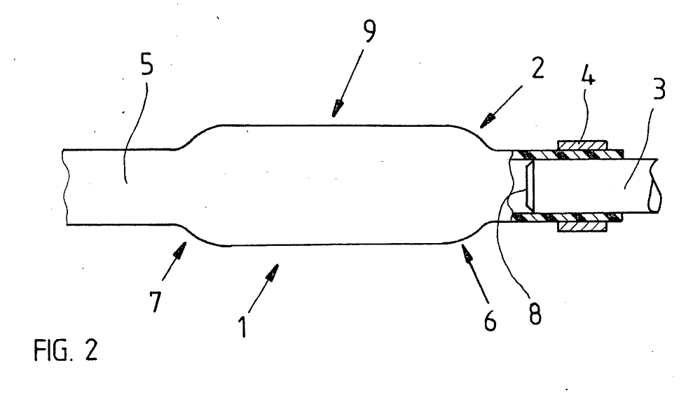

FIG. 2 shows the same arrangement in a plan view.

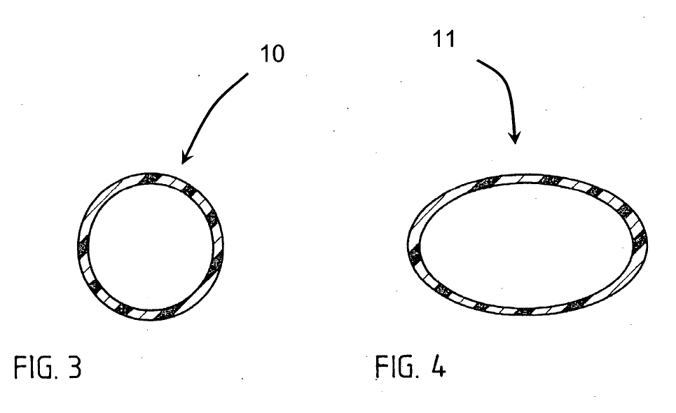

FIG. 3 shows the cross section 10 of the molded hose 1 in the section III-III in FIG. 1 and FIG. 4 shows the cross section 11 of the molded hose in the section IV-IV in FIG. 1, as is realized up to a pressure that is considerably below the operating pressure. If the pressure rises beyond this pressure, the segment 9 of the molded hose departs from its oval cross-sectional form 11 and assumes an approximately circular cross section as the molded hose can accommodate a greater fluid volume with this cross-sectional form. This deformation is elastically reversible, only the inherent rigidity of the completely vulcanized molded hose 1 in the segment 9 has to be overcome. In this way, it is possible, even with a sudden increase in pressure, to accommodate very rapidly the additional volume that is pressed into the molded hose 1. Pressure spikes are thereby taken up so that there is no or only unnoticeable noise development in the molded hose 1.

It is understood that the foregoing description is that of the preferred embodiments of the invention and that various changes and modifications may be made thereto without departing from the spirit and scope of the invention as defined in the appended claims.

### LIST OF REFERENCES

### Part of the Description

1 Molded hose
2 Connecting end
3 Hose nipple
4 Hose clamp
5 Connecting end
6,7 Transition region
8 End of the hose nipples 3
9 Segment with the cross section that departs from the circular cross section of the molded hose 1
10 Cross section of the connecting end 2 or 5
11 Cross section of the segment 9

What is claimed is:

1. An elastic hose assembly for a return line conducting a fluid at an operating pressure, the return line being a return line of a hydraulic power-assisted steering system in a motor vehicle, the elastic hose assembly comprising:
first and second connecting fittings;
an elastic hose of finite length having first and second connecting ends tightly clamped to corresponding ones of said connecting fittings;
said elastic hose being of a matrix of elastomeric material having reinforcement embedded therein;
said elastic hose being configured as a molded hose having an overall length and said elastic hose having a plurality of segments;
at least one segment of said overall length having a first cross section departing from a circular cross section up to a pressure clearly below said operating pressure;
said one segment having a length less than said overall length of said molded hose; and,
the remainder of said segments having an approximately circular cross section.

2. The elastic hose assembly of claim 1,
said remainder of said segments being defined by said first and second connecting ends;
said first connecting end being clamped to said first connecting fitting at a first clamping zone;
said second connecting end being clamped to said second connecting fitting at a second clamping zone;
said first connecting end and said one segment conjointly defining a first transition region of predetermined length;
said second connecting end and said one segment conjointly defining a second transition region of predetermined length;
the transition in each of said first and second transition regions being continuous over the predetermined length of the corresponding transition region;
said first transition region being spaced from said first clamping zone so as to cause said first transition region to be outside of said first clamping zone; and,
said second transition region being spaced from said second clamping zone so as to cause said second transition region to be outside of said second clamping zone.
